(19) United States
(12) Patent Application Publication
(10) Pub. No.: US 2010/0307273 A1
(43) Pub. Date: Dec. 9, 2010

(54) Method of Manufacture of a Gearbox and a Gearbox Made by the Method

(75) Inventors: Neil Adcock, Jarna (GB); Patrick Adcock, Loughborough (GB)

Correspondence Address: Adams and Reese LLP, 1221 McKinney Street, Suite 4400, Houston, TX, 77010, US

(73) Assignee: H R Adcock Limited a corporation

(21) Appl. No.: 12/742,332

(22) PCT Filed: Nov. 12, 2008
(86) PCT No.: PCT/GB2008/003797

§ 371 Date: Aug. 25, 2010

(30) Foreign Application Priority Data
Nov. 12, 2007 (GB) 0722199.7

(51) Int. Cl. F16H 55/22; B23P 11/00

(52) U.S. Cl. 74/434; 29/893.1

(57) ABSTRACT

With reference to FIG. 1, the present invention provides a gearbox (10) which has: an end stop (40) deformed during manufacture to set an exact spacing in the gearbox (10); bearing surfaces engaging a shaft (12) which are roller burnished or swaged; spigots (45-48) which are in a pre-assembly stage of manufacture forced into matching sockets and deformed by this process to set alignment of gearbox casing halves; and a gear (11) which comprises a plastic gear wheel sandwiched between two metal load-bearing elements and secured on the shaft (12) by shoulders rolled in the shaft (12).

The present invention relates to a method of manufacture of a gearbox and a gearbox made by the method.

Small gearboxes are used in many applications; one example is in seat moving mechanisms in automobiles. The efficiency of such gearboxes is greatly affected by alignment of components in the gearboxes and reduction of tolerances and the surface finish and metallurgy of bearing surfaces, this also has a great effect on the noise emitted by the gearbox during use and wear of gearbox components and hence gearbox life.

In a first aspect the present invention provides a method of manufacture of a gearbox comprising:

forming a plurality of gearbox casing components each with an end stop feature;

in a pre-assembly stage, bringing the formed gearbox casing components together prior to final assembly with the end stop features of the casing components together defining an end stop internal to the casing;

applying pressure on the end stop to deform the end stop;

disassembling the gearbox casing components;

assembling the gearbox components around an end of a shaft, the shaft having a gear mounted thereon for rotation therewith and the assembled gearbox casing components encasing the gear; and

bringing the end of the shaft into abutment with the end stop either directly or via one or more spacer element(s) wherein:

deformation of the end stop in the pre-assembly stage sets a distance between the end stop and a surface of the gearbox casing which in the assembled gearbox faces a side surface of the gear, the said gear side surface facing away from the end stop.

In a second aspect the present invention provides a method of manufacture of a gearbox comprising:

forming a plurality of gearbox casing components which when assembled together provide a cylindrical bearing surface for a shaft;

in a pre-assembly stage forcing the gearbox casing components together around a former which has rollers mounted therein which engage the bearing surface of the gearbox casing and indent the bearing surface as the casing components are forced together;

rotating the former to roll the rollers around the bearing surface to deform the bearing surface;

disassembling the gearbox casing components from around the former; and

assembling the gearbox components around an end of a shaft, the shaft having a gear mounted thereon for rotation therewith and the assembled gearbox casing components encasing the gear.

In a third aspect the present invention provides a method of manufacture of a gearbox comprising:

forming a plurality of gearbox casing components, a first of the gearbox casing components having spigots and a second of the gearbox components having matching sockets;

in a pre-assembly stage forcing the spigots of the first gearbox components into the sockets of the second gearbox component and in doing so deforming the spigots to fit into and match in shape with the sockets;

disassembling the gearbox casing components; and

assembling the gearbox components around an end of a shaft, the shaft having a gear mounted thereon for rotation therewith and the assembled gearbox casing components encasing the gear.

In a fourth aspect the present invention provides a method of manufacture comprising:

moulding a toothed gear wheel from plastic having a central aperture and slots in an annular surface defining the central aperture;

fashioning a pair of metal load-bearing elements each having a central aperture therethrough and, a load-bearing surface;

mounting the gear wheel and the bearing elements on a metal shaft, with the load-bearing elements sandwiching the plastic gear wheel and with a part of at least one of the load-bearing elements extending through the central aperture in the gear wheel to abut the other load-bearing element;

deforming the metal of the shaft to form a pair of annular shoulders on the shaft which engage the load-bearing surfaces of the load-bearing elements, with the forces applied to the load-bearing surfaces being transmitted through directly abutting faces of the load-bearing elements; and

allowing axial movement of the gear wheel and load-bearing elements as the shoulders are formed so that the shoulders fix the gear wheel in position axially on the shaft.

In a fifth aspect the present invention provides a gearbox comprising:

a plurality of metal casing components which together define both an internal end stop and a cylindrical burnished bearing surface for engaging a shaft, a first of the casing components having a plurality of spigots and a second of the casing components having has a plurality of matching sockets;

a metal shaft having mounted thereon for rotation therewith a toothed gear, the toothed gear comprising a plastic toothed gear wheel secured between a pair of metal bearing elements which are in turn engaged by a pair of shoulders formed integrally in the metal shaft; and

a worm gear; wherein:

the metal casing components encase and secure both the metal shaft with the toothed gear mounted thereon and also the worm gear, with the worm gear meshing with the toothed gear and with an axis of rotation of the worm gear being spaced apart from the shaft and perpendicular to a plane which includes an axis of rotation of the shaft;

the shaft is secured axially in the gearbox casing between the end stop, which faces an end of the shaft, and a gearbox casing surface which faces a bearing surface of one of the bearing elements, said bearing surface facing away from the end stop; and

a cylindrical portion of the shaft is surrounded by the cylindrical bearing surface formed by the assembled casing components.

Preferred embodiments of the present invention will now be described with reference to the accompanying drawings, in which:

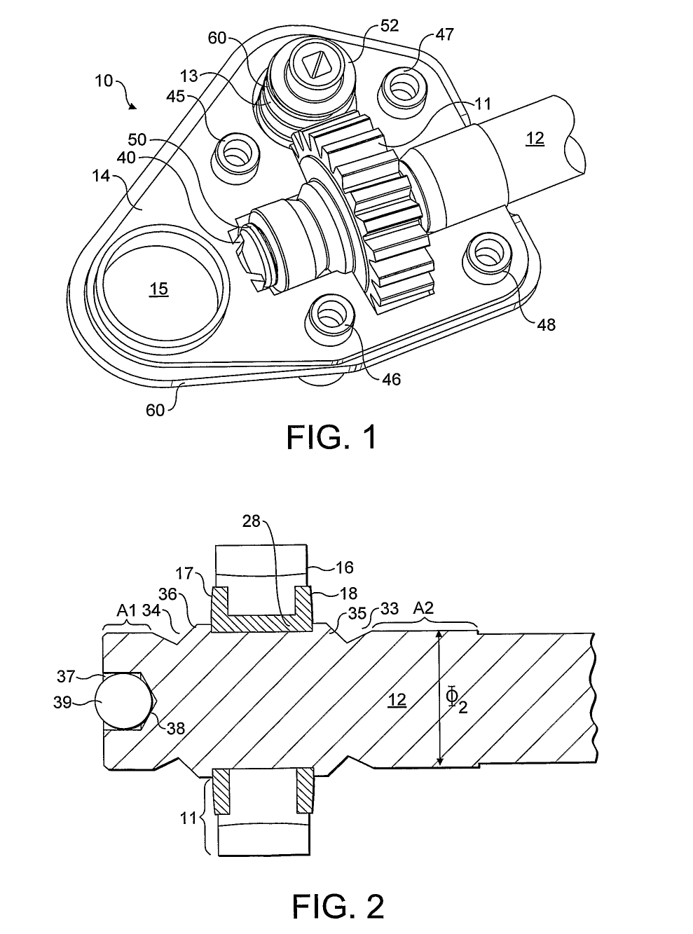

FIG. 1 is a perspective part-disassembled view of a first embodiment of gearbox according to the present invention;

FIG. 2 is a cross-section through a first shaft and first gear of the FIG. 1 gearbox, showing how the gear is fixed in place on the shaft;

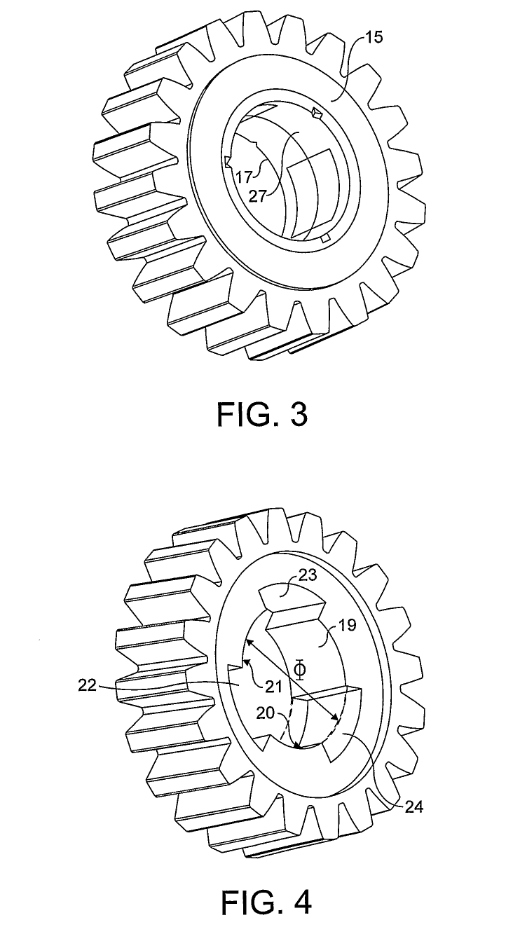

FIG. 3 is a perspective view of the first gear shown in FIGS. 1 and 2, prior to fixing in place on the shaft;

FIG. 4 is a perspective view of a first component of the FIG. 3 gear;

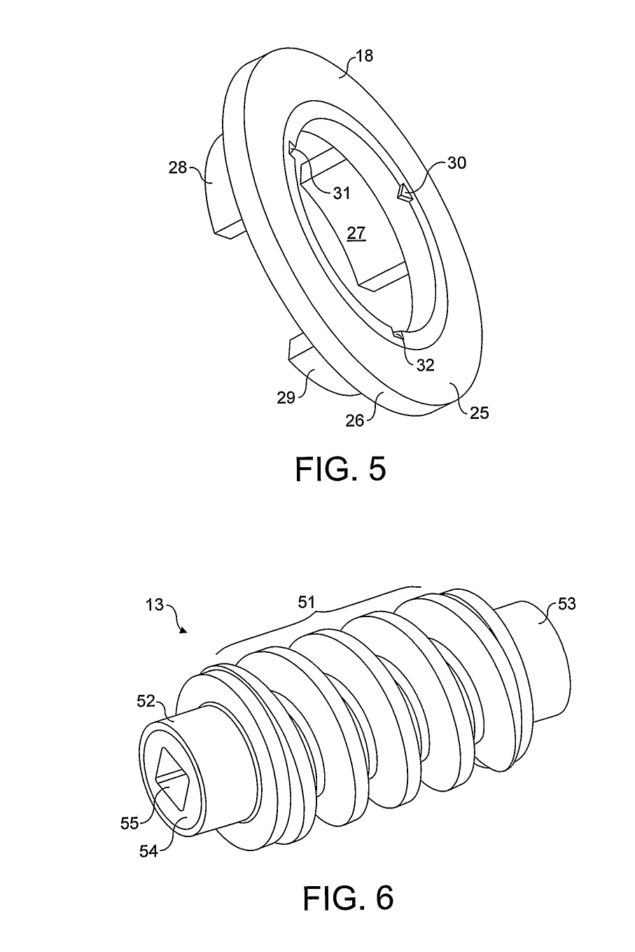

FIG. 5 is a perspective view of a second component of the FIG. 3 gear;

FIG. 6 is a view of a first component of the FIG. 1 gearbox;

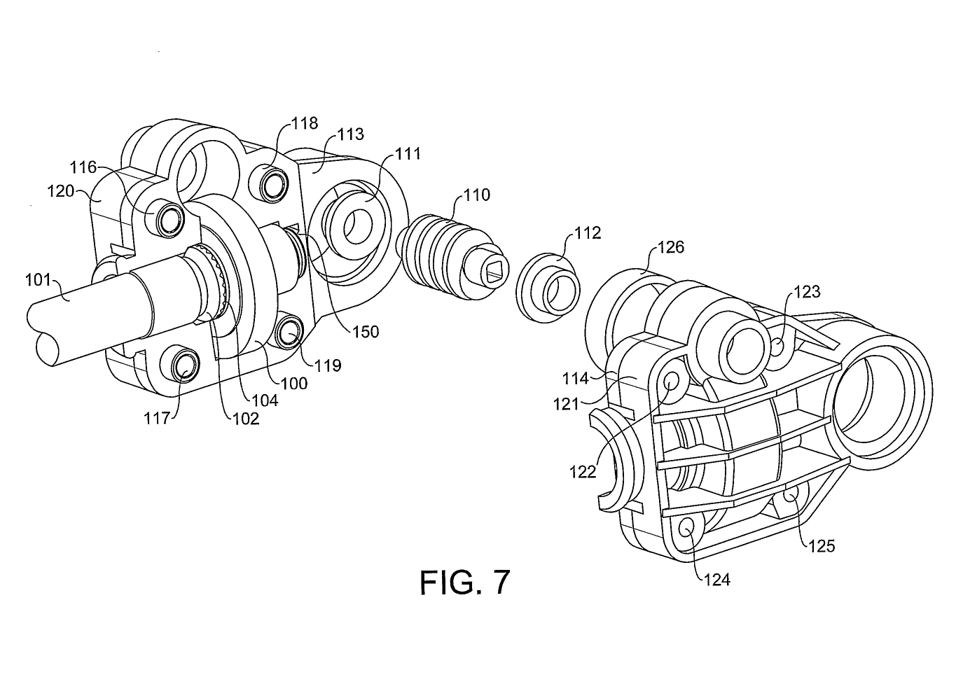

FIG. 7 is an exploded view of a second embodiment of a gearbox according to the present invention;

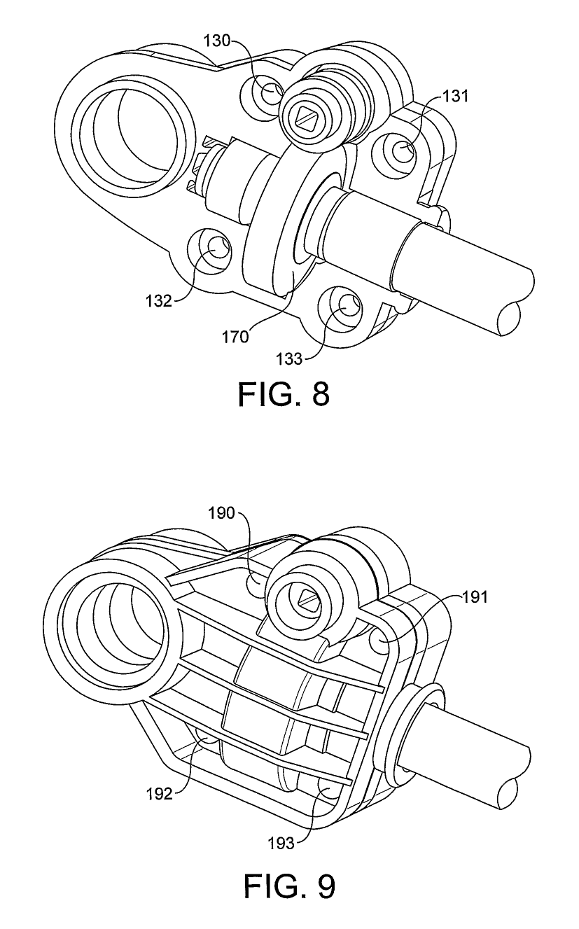

FIG. 8 is a view of a second embodiment of gearbox according to the present invention when partly assembled,

FIG. 9 is a perspective view of the FIG. 7 and FIG. 8 gearbox completely assembled; and

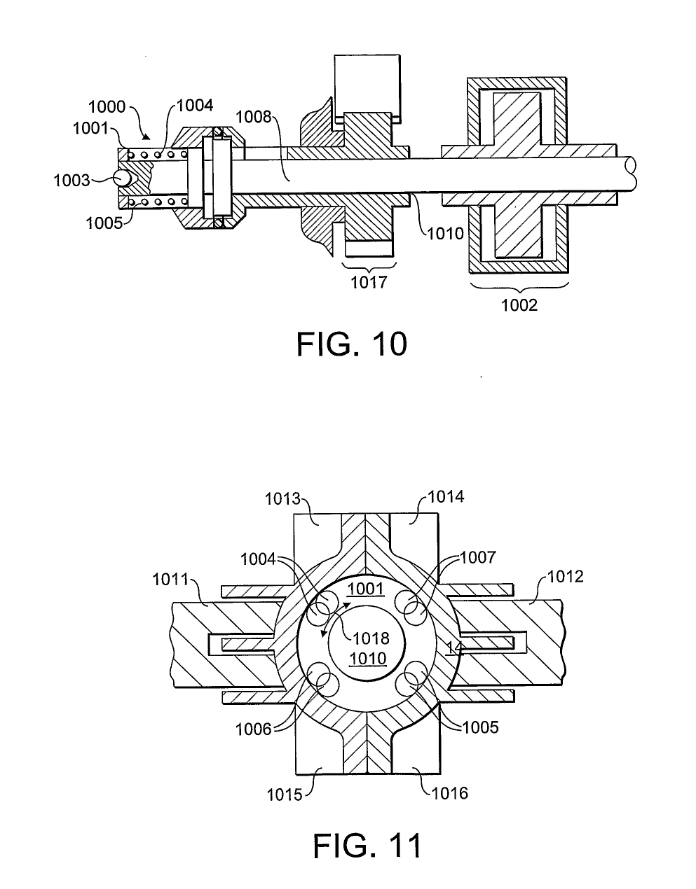

FIG. 10 is an illustration of manufacturing apparatus for making the gearboxes of FIGS. 1 to 9;

FIG. 11 is a detail view of the FIG. 10 apparatus, illustrating the method of operation;

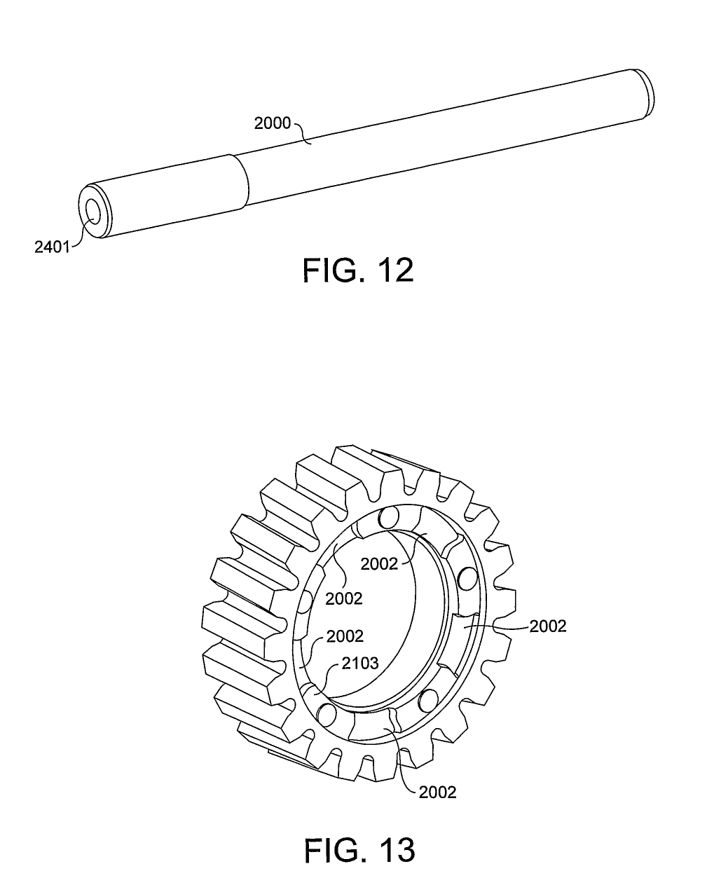

FIG. 12 is a view of a shaft used in third embodiment of gearbox according to the present invention;

FIG. 13 is a perspective view of a first side of a plastic gear wheel component of the third embodiment of gearbox;

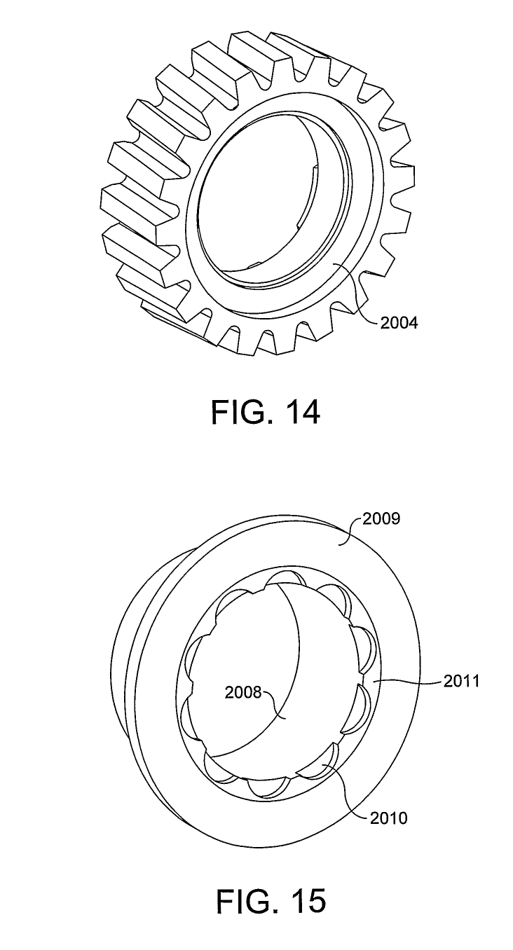

FIG. 14 is a perspective view of the a second side of the FIG. 13 plastic gear wheel component;

FIG. 15 is a perspective view of a first side of a thrust bearing washer of the third embodiment of gearbox;

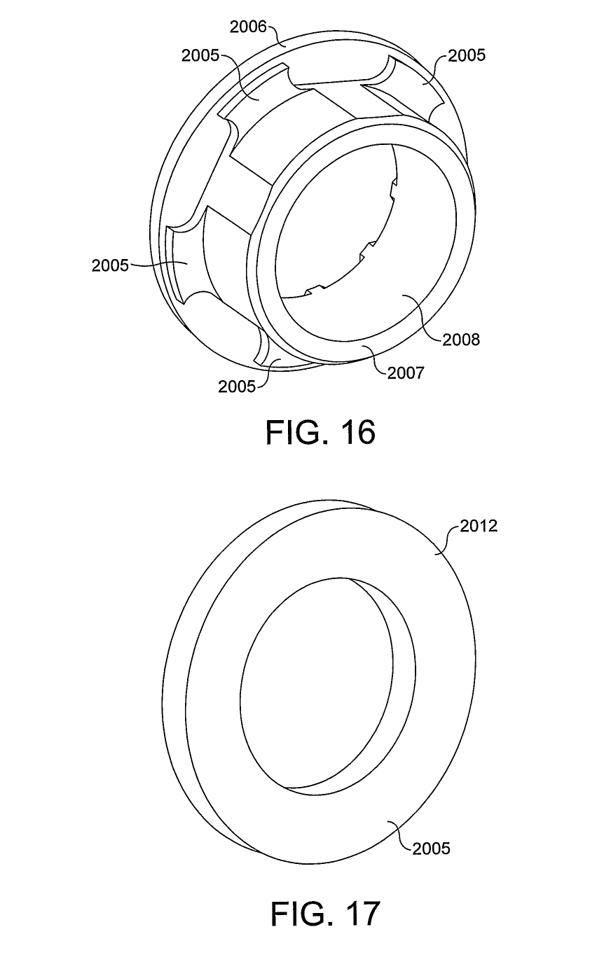

FIG. 16 is a perspective view of a second side of the thrust bearing washer of FIG. 15;

FIG. 17 is a perspective view of a fine blank washer of the third embodiment of gearbox;

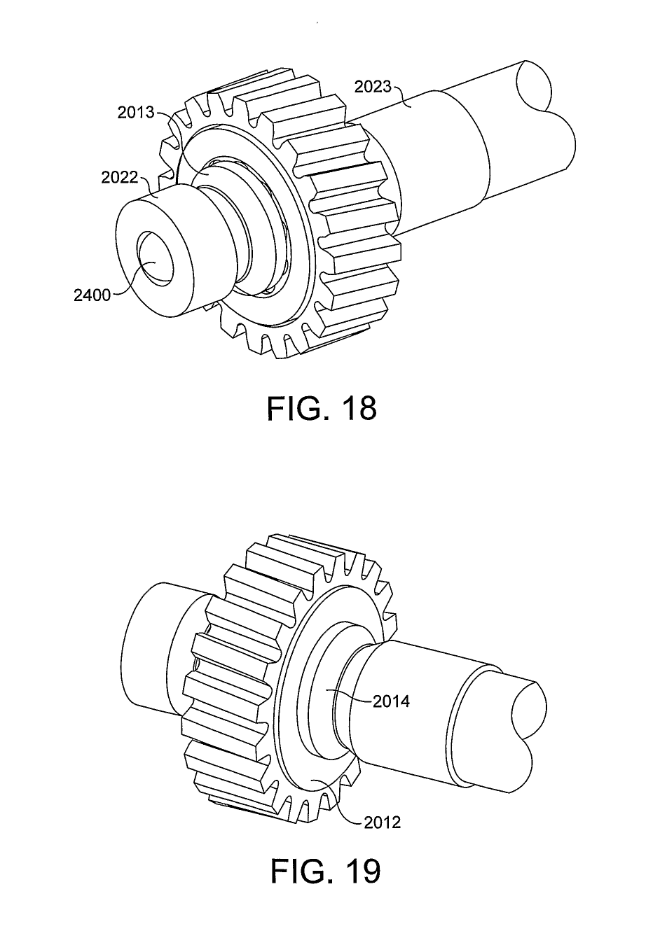

FIG. 18 shows a perspective view from a first side of a sub-assembly of the FIG. 12 shaft, FIG. 13/14 plastic gear wheel, FIG. 15/16 thrust bearing washer and FIG. 17 fine blank washer;

FIG. 19 shows a perspective view from a second side of the sub-assembly of FIG. 18;

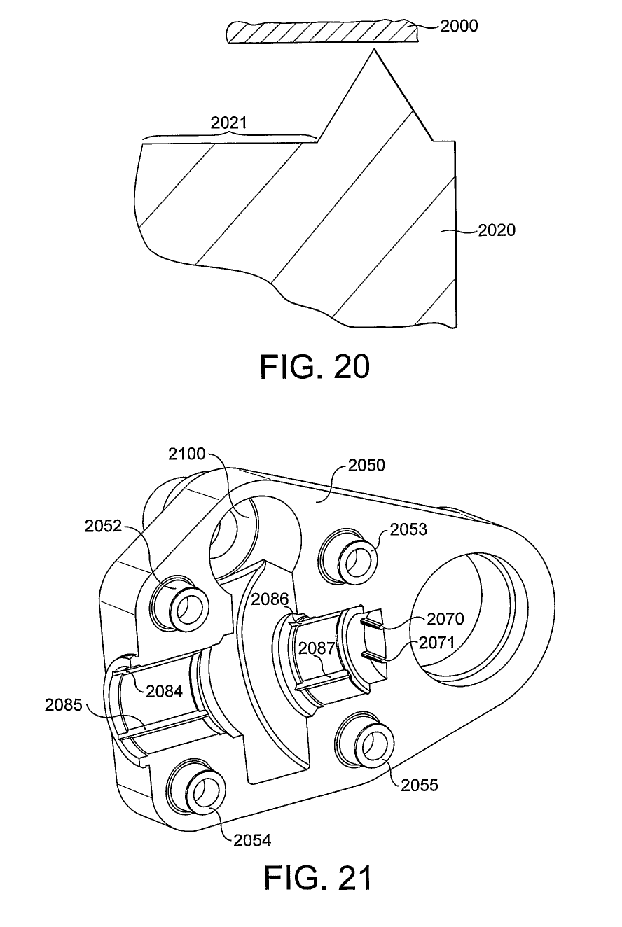

FIG. 20 is a schematic illustration of how shoulders are formed on the shaft of FIG. 12;

FIG. 21 is a perspective view of a first casing half of the third embodiment of gearbox;

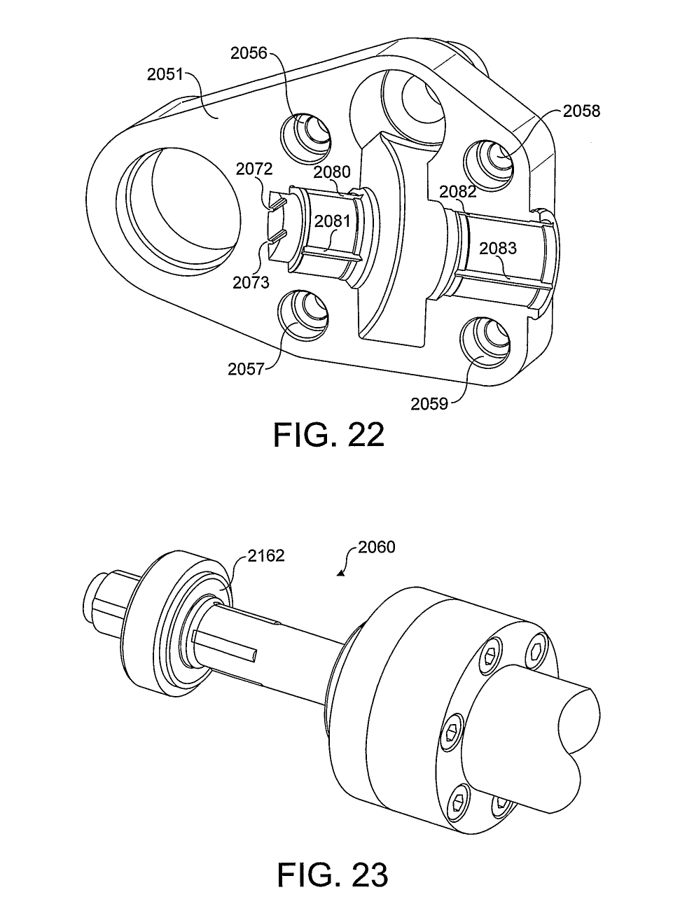

FIG. 22 is a perspective view of a second casing half of the third embodiment of gearbox;

FIG. 23 is a perspective view from a first side of a roller burnishing tool used in the manufacture of the third embodiment of gearbox;

FIG. 24 is a perspective view from a second side of the roller burnishing tool of FIG. 23;

FIG. 25 is a view showing the roller burnishing tool of FIGS. 23 and 24 in place in the gearbox casing half of FIG. 22;

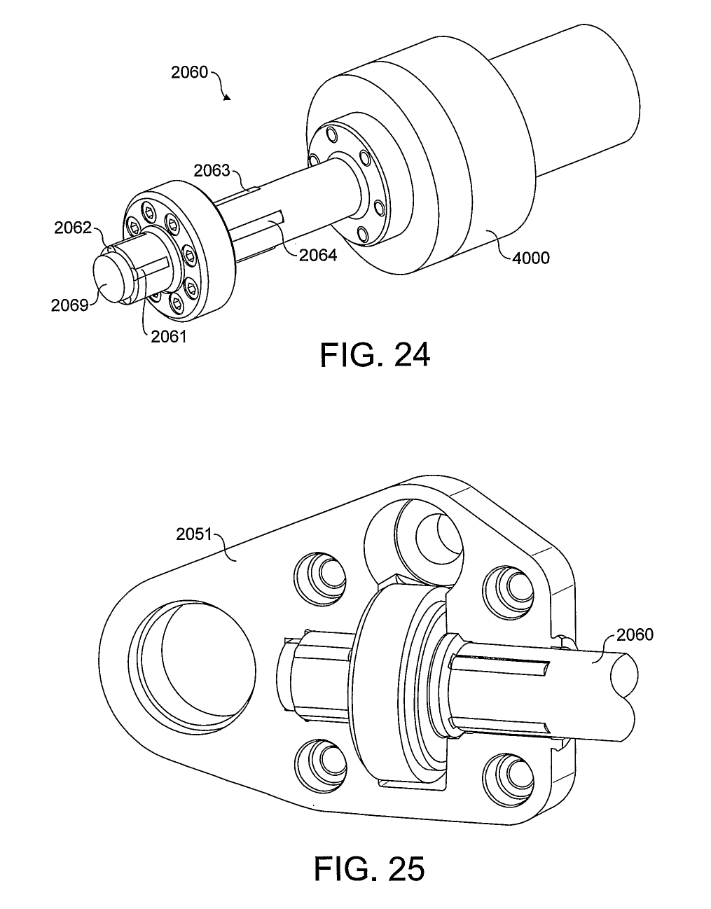

FIG. 26 is a view of the gearbox casing halves of FIGS. 21 and 22 mounted on the tool of FIGS. 23 and 24, with arrows to indicate forming motions;

FIG. 27 is a perspective view of a worm gear of the third embodiment of gearbox;

FIG. 28 is a perspective view of a washer for use with the worm gear of FIG. 27;

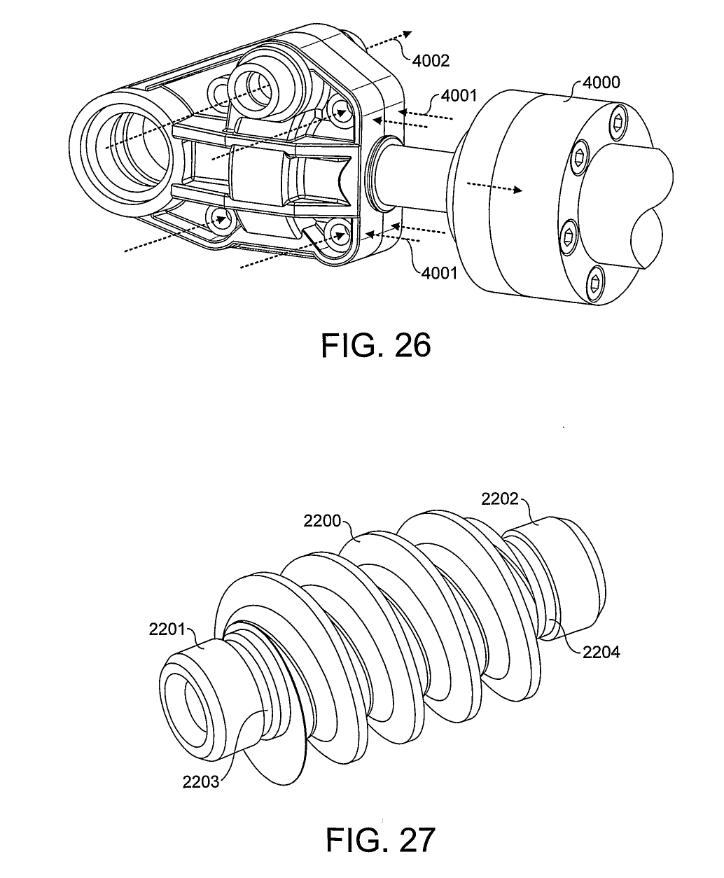

FIG. 29 is a perspective view of one end of the worm gear of FIG. 27, showing the FIG. 28 washer fixed in place on the worm gear of FIG. 27;

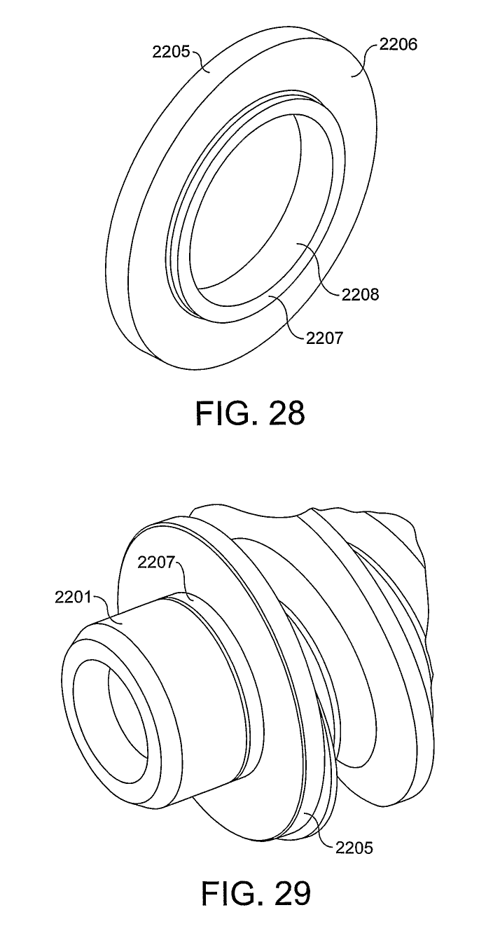

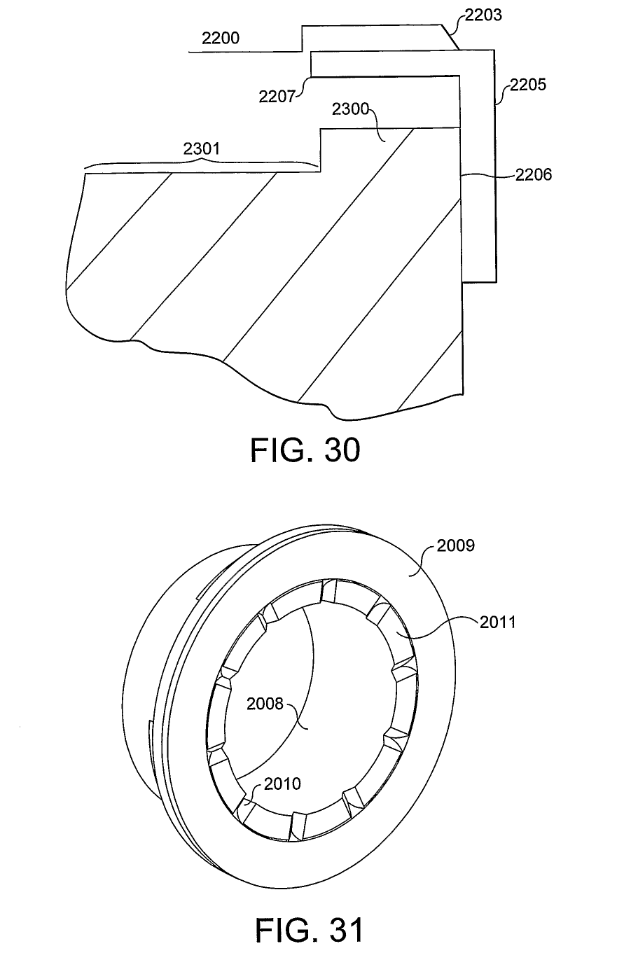

FIG. 30 is a schematic illustration of how the washer of FIG. 28 is fixed in place on the worm gear of FIG. 27;

FIG. 31 is a perspective view of a first side of an alternative thrust bearing washer to that shown in FIG. 15;

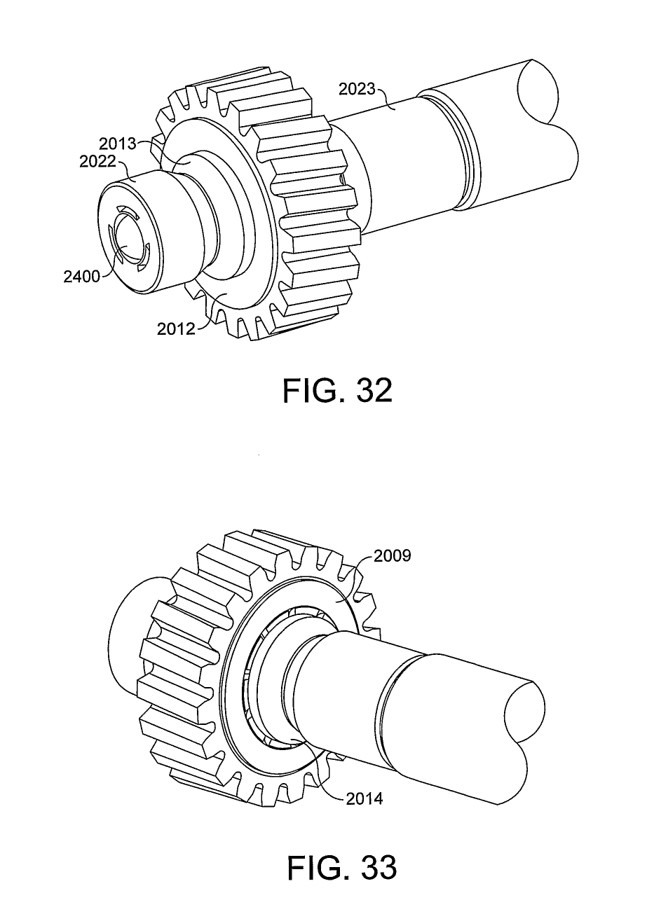

FIG. 32 shows a perspective view from a first side of a sub-assembly including the FIG. 31 thrust bearing washer;

FIG. 33 shows a perspective view from a second side of the sub-assembly of FIG. 32;

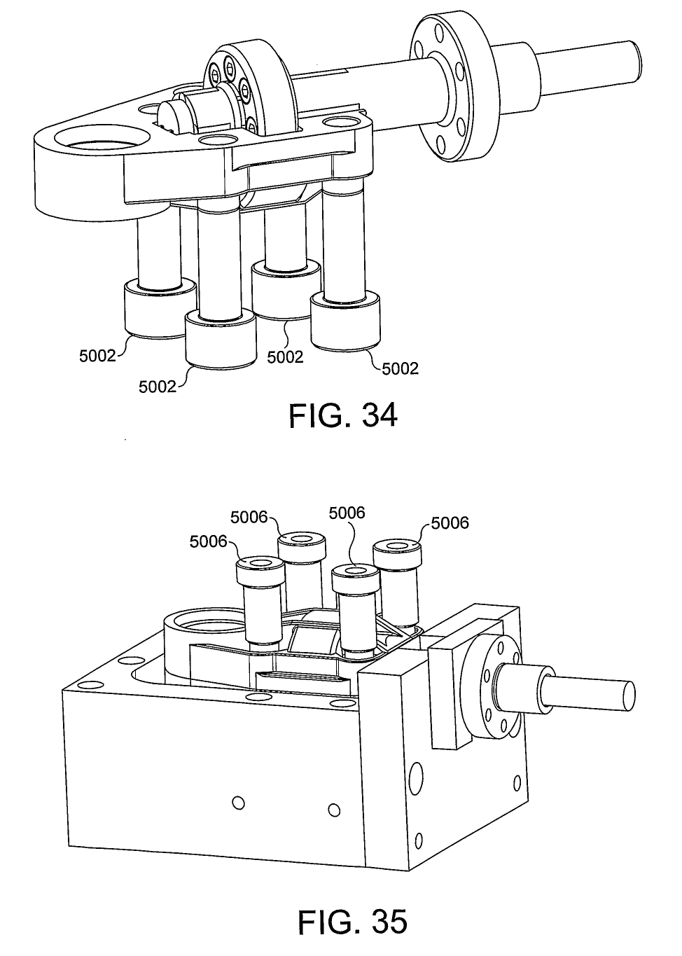

FIG. 34 is a perspective view of a part of a jig for use in the disclosed method;

FIG. 35 shows a perspective view depicting further features of the jig; and

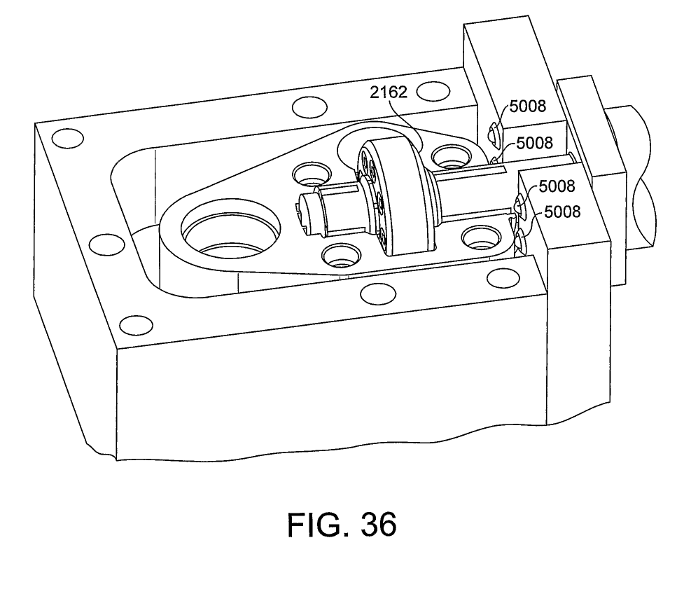

FIG. 36 shows another perspective view from a second side depicting further features of the jig.

FIG. 1 shows a gearbox 10 comprising a gear 11 mounted co-axially on a shaft 12 for rotation with the shaft 12. The gear 11 meshes with a worm gear 13 whose axis is perpendicular to the axis of gear 11. The gear 11, the worm gear 13 and an end of the shaft 12 illustrated in the Figure are journalled in a gearbox casing 14 which has an aperture 15 allowing the gearbox 10 to be secured in place.

FIG. 2 shows in cross-section the end of the shaft 12 illustrated in FIG. 1 and also the gear 11. The gear 11 comprises three components, an injection-moulded plastic toothed gear wheel 16 and two metal thrust bearings 17, 18, typically of mild steel. The component 16 is shown on its own in FIG. 4. It will be “superfinished” to give a low coefficient of friction and to hence generate less heat in use and give quieter operation (when compared with a similar metal gear). The component 16 is formed with an inner diameter which is equal to the exterior diameter Φ₂ of the end of shaft 12 (see FIG. 2); this inner diameter is formed by 3 curved surfaces 19, 20, 21 (see FIG. 4).

The plastic gear wheel 16 has three slots 22, 23, 24 (see FIG. 4) which are recesses extending radially out from diameter Φ. These slots enable interlocking of the gear wheel with the bearings 17, 18. One of the bearing components, the component 18, is shown in FIG. 5. It has a planar front surface 25, which in use provides a bearing surface, provided on an annular ring 26, and, extending axially rearwardly from the annular ring 26, three teeth 27, 28, 29. The teeth 27, 28, 29 matingly engage the slots 22, 23, 24 to fix the component 18 to the gear 16 to rotate together. The bearing component 17 is similarly fashioned. When assembled the teeth of the bearing components 17, 18 meet end-to-end as can be seen in FIG. 2. The inner radial surface of the gear 11 is made up of inner radial surfaces of the bearing components 17, 18 which define windows through which parts of the plastic gear wheel 16 extend.

An inner part of the thrust face (e.g. 25) of each washer 17, 18 is chamfered to provide a conical surface which has a plurality of notches defined therein. As an example, notches 30, 31, 32 are shown in FIG. 5. Each notch 30, 31, 32 is aligned with a midpoint of a tooth 27, 28, 29.

During assembly the injection moulded plastic gear wheel 16 is sandwiched between the two metal washers 17, 18, with the teeth of the washers 17, 18 extending through the slots 22, 23, 24 of the plastic gear wheel 16. This leaves a component as shown in FIG. 3. This component is then slipped over the end of the shaft 12, which is initially of a constant diameter Φ₂.

The gear wheel 16 is next fixed axially in place on the shaft 12 by a “shoulder rolling” process, as previously described in EP 1000686. In this process metal flows from the regions 33, 34 to form annular shoulders 35, 36. In the process the material flow to form shoulder 35 and the material flow to form shoulder 36 causes movement of the gear 16 to locate the gear 16 exactly in a desired axial location on the shaft 12. The flowing metal flows into the notches 30, 31 and 32 described previously. The shoulders 35, 36 securely locate the gear 16 on the shaft 12 in an axial direction and also lock the gear 16 to rotate with the shaft 12. The notches 30, 31, 32 help in securing the gear 16 to rotate with the shaft 12. The metal bearing components 17, 18 react loading applied on the gear 16 during the forming of the shoulders 35, 36. They thereby enable the use of a gear 16 which is predominantly injection moulded plastic to be located on the shaft 12 with a “shoulder rolling” process. An injection moulded plastic gear itself would not be capable of withstanding the loading and for this reason the thrust bearing components 17, 18 are essential.

The shoulder rolling process also causes the diameter of the shaft between the shoulders to increase, to take up any clearance between the shaft and adjacent metal bearing components 17,18. Thus, while prior to shoulder rolling there is a clearance fit between the metals bearing components 17,18 and the shaft, after shoulder rolling there is a “size and size” (i.e. matched diameters) fit, which prevents the gear from rocking on the shaft. The gearbox of the invention can be used in a seat adjustment mechanism of a vehicle and thus must be able to withstand crash loads. Such crash loading is transmitted from the metal of the shaft through the metal of the bearing components to the metal of the gearbox casing, without the plastic gear having to transmit such high forces.

The exact concentricity and exact perpendicularity of the shoulder rolling dies are transmitted to the gear and shaft sub-assembly during the shoulder rolling process. At the front end of the shaft 12 there is formed by a drilling operation a closed bore 37 having a conical end face 38 (see FIG. 2). In this bore 37 there is located a ball bearing 39.

In a parallel manufacturing process the gearbox casing is formed. An important feature of the gearbox casing is a deformable end stop 40 (see FIG. 1) provided by features of one or more of the gearbox casing components, e.g. the gearbox casing component 14. As shown, the deformable end stop 40 comprises a frusto-conical component with a 38° taper angle. The frusto-conical end stop 40 has one half formed by one gearbox casing component 14 and the other half formed by a mating gearbox casing component.

During formation of the gearbox, the gearbox casing components are initially brought together around a forming mandrel 1000 (see FIGS. 10 and 11). The mandrel 1000 has a cylindrical part 1001 of a diameter equal to the diameter of the end of the shaft 12 shown in FIG. 1. Slidable in the mandrel 1000 is a rod 1010 connected to a hydraulic actuator 1002 which will control the position of the rod 1010 axially. The actuator 1002 is associated with precise position measuring equipment. The rod 1010 has a ball bearing 1003 located in a socket at its front end, much the same as the shaft 12. The mandrel 1000 and rod 1010 with the ball bearing 1003 at its front end will be enclosed between the casing parts when they are assembled around it. The rod 1010 is then advanced by the hydraulic actuator 1002 within the mandrel 1000 and within the casing assembled around the mandrel 1000 (with the assembled casing held static), and will plastically deform the end stop 40. This is done to set exactly the distance between the front face of the end stop 40 (engaged by shaft 12 in use) and an opposed facing surface in the gearbox casing which forms part of the cavity in which the gear 11 is located in use. It is important to set exactly the distance between these two points. The distance will not be set exactly enough in the casting of the gearbox casing components. These two surfaces provide the faces which accurately position the shaft 12 and the gear wheel 11 in place in the gearbox casing in use.

The displacement of the rod 1010 will be carefully controlled, to account for the fact that the end stop 40 deforms both elastically and plastically. The control unit for the movement of the rod 1010 will be encoded to give a displacement which will give a final position of the end stop (after the end stop has expanded elastically on removal of pressure from the end stop) equivalent to that desired.

Also seen in FIG. 1 are four spigots 45, 46, 47, 48, which are tapered, having an external diameter which reduces away from the face of the casing part 14. Each spigot is hollow in nature. The frusto-conical exterior surface of each spigot has a 6° taper. The facing casing part has matching sockets in which the spigots locate when the casing parts are brought together. This can best be seen with the embodiment of the invention illustrated in FIGS. 7, 8 and 9. This embodiment is identical in most respects to the embodiment of FIGS. 1 to 6, but the casing components have a slightly different shape and configuration and also the spigots and sockets are swapped to be on opposite sides of the gearbox casing.

In FIG. 7 four spigots 116, 117, 118, 119 can be seen provided on a gearbox casing part 120. As described above, these are hollow with a frusto-conical exterior surface with a 6° taper. These align with and are inserted into corresponding sockets 130, 131, 132, 133 which are shown in FIG. 8. These sockets have tapering side surfaces which match the exterior surfaces of the spigots.

In manufacture of the gearbox the casing parts 120, 121 (like the casing part 14 and its counterpart) are brought together around a mandrel, as described above, prior to final assembly. The spigots (e.g. 116, 117, 118, 119) are forced into the corresponding sockets (e.g. 130, 131, 132, 133). The spigots (116,117,118,119) are deformed by their insertion with the corresponding sockets (130,131,132,133). The spigots (116,117,118,119) are initially sized such that the leading edges of the spigots engage the socket surface 1 mm from the end of the matching frusto-conical surface. The plunger forcing the casing components together is then advanced a further pre-selected distance so that the spigots deform to take up a typical 0.1 mm clearance left between the spigot and socket at the initial point of contact. The material of the spigots will flow most where there is least resistance. This improves the concentricity of fit of the spigot in socket. The spigot material deforms plastically whilst the socket material remains in an elastic state. Once the spigots have been fully advanced then the casing components are kept together as the metal of the spigots and the metal of the sockets relax, the relaxation of the socket metal in its elastic state typically giving rise to further plastic deformation of the spigots.

In the manner described above the alignment of the casing parts is set and the end stop suitably deformed while the parts are held in place around a mandrel. Once the deformation processes described above are completed then a bearing surface finishing operation can be carried out, as will now be described.

The mandrel 1000 used in the forming process is also provided with rollers 1004, 1005, 1006, 1007 (see FIG. 11) journalled in the mandrel 1000 to each rotate about an axis individual thereto which is parallel and spaced apart from a rotational axis 1008 of the mandrel (see FIG. 10). The rollers 1004, 1005, 1006, 1007 extend radially outwardly from the mandrel 1000 outside the surface of the mandrel 1000. When the gearbox casing parts are brought together around the mandrel 1000 they are forced together using hydraulic pressure by applied via rams 1011, 1012. The rollers 1004, 1005, 1006, 1007 indent slightly in bearing surfaces of gearbox casing parts as the parts are forced together. Then the casing parts are held together by blocks 1013, 1014, 1015, 1016. The mandrel 1000 is connected to a rack and pinion arrangement 1017 (see FIG. 10) and this is used to rotate the mandrel 1000 in one sense (e.g. clockwise) to roller burnish the bearing surfaces of the gearbox casing parts; this is illustrated by showing each of the rollers 1004, 1005, 1006, 1007 in two rotational positions in FIG. 11 and by the arrow 1018. This gives a very good surface finish to the journal parts of the finished gearbox casing and improves the metallurgy of the finished gearbox casing surfaces, which reduces friction in operation and hence reduces wear and noise. The process also ensures that the journals provide a very accurate axial positioning of the shaft 12 in the finished gearbox. The roller burnished bearing surfaces are those engaged by the annular surfaces A₁ and A₂ of the shaft 12 (shown in FIG. 2).

Instead of roller burnishing the bearing surfaces as described above, the surfaces can be finished by a swaging process. In such a process the rollers 1004, 1005, 1006 and 1007 will indent the casing metal deeper than in the burnishing process and will displace metal circumferentially around the bearing surfaces as the rollers are rotated through 90 degrees. Typically a pair of undercuts or slots will be cast in the bearing surface to provide voids into which metal can be displaced during the swaging process. The greater deformation of the bearing surfaces by swaging can give a better surface finish than burnishing and a tighter tolerance to the formed cylindrical bearing surfaces and the alignment between them.

After a suitable dwell period following completion of the processes described above, the two casing parts are then separated from each other.

Once the casing components have been through the pre-assembly stage and the end stop (40 in FIGS. 1 and 150 in FIG. 7) and spigots (45, 46, 47, 48 in FIGS. 1 and 116, 117, 118, 119 in FIG. 7) deformed, and the bearing surfaces superfinished and then separated, next the casing components are used to assemble the gearbox as shown in FIG. 1 or FIG. 7. The casing components will undergo their pre-assembly operations in parallel with the mounting of the gear on the shaft (e.g. the mounting of gear 11 on shaft 12 as shown in FIG. 2; the gear 100 is mounted in the shaft 101 in a similar manner, using “shoulder rolling”, save that corrugations are provided on the side surfaces of gear 100, into which the deformed material flows to lock the gear 100 rotatably on shaft 101).

On assembly the shaft 12 and gear 11 are located between the pre-deformed casing components (e.g. 14), with the insertion of a hardened spacer 50 between the end of shaft 12 and the end stop 40, the ball bearing 39 engaging the spacer 50. The worm gear 60 is mounted cross-axially to the axis of shaft 12 and meshed with gear 11. Two “top hat” zinc (or zinc alloy) bearing caps 52 and 53 (see FIG. 6) are located over the ends of the worm gear 13 to provide bearings for the gear. The worm 13 itself is made of mild steel. It has a thread rolled helical thread 51 and cylindrical end parts, e.g. 54, over which the bearing caps 52, 53 are loaded, there being a square socket 55 in at least one end part 54 for receiving a matched end of an input shaft of the gearbox. There will be a 20:1 gear ratio typically.

The casing parts (e.g. 14) are held together in final assembly by rivets or screws securing spigots 45, 46, 47, 48 in the matching sockets. The pre-assembly operations performed on the casing components ensure a good and exact fit of all components in the final assembly.

In a similar fashion the components of the FIG. 7 gearbox are assembled together. Once again a mild steel worm gear 110 is provided with steel “top hat” bearing caps 111 and 112 (typically of a grade of hard-wearing steel which can provide a low friction surface). In this case an additional annular ring 126 is provided to surround a part of the worm gear 110 that does not engage with the gear 100. The pre-deformed spigots 116, 117, 118, 119 will provide a “size-in-size” perfect fit in the matching sockets to secure the components in place to the gearbox. The pre-deformed end stop 150 will ensure that there is a close registration of the bearing element 170 (see FIG. 8) which forms part of gear 100, with its opposed face in the gearbox casing, thus ensuring that there is little movement of the gear 11 within the casing in use, minimising noise and wear.

A fully assembled gearbox as shown in FIG. 9. The gearbox casing parts 120 and 121 have been fastened together by rivets 190, 191, 192, 193 (or screws) which extend through the apertures 122, 123, 124, 125 into the spigots 116, 117, 118, 119.

The principles behind the present invention are now further explained with reference to a third embodiment of gearbox illustrated in FIGS. 12 to 30. In FIG. 12 there can be seen a turned blank mild steel shaft 2000. In FIGS. 13 and 14 there can be seen a moulded plastic gear 2003, having keying features 2002 on a single face in a sunken annular surface portion 2103 (see FIG. 13). The opposite face (see FIG. 14) also has a sunken annular section 2004, but this is planar. The keying features 2002 mate with opposite keying features 2005 on a mild steel bearing washer 2006 (see FIG. 16) and this engagement locks the moulded plastic gear 2003 and the bearing washer 2006 together to rotate together and to transmit torque when the gear is driven.

The metal bearing washer 2006 has a first side shown in FIG. 16 with the keying features 2002 that engage with the keying features 2002 on the moulded gear 2003; this side also has an abutment surface 2007 at the end of a hub in which is formed a central bore 2008 of the same diameter the same as the shaft 2000 which allows mating engagement with the shaft 2000. On the other side of the bearing washer 2006, seen in FIG. 15 there is provided a bearing face 2009 which provides a thrust face which bears against an opposed thrust face in a zinc die cast housing (as will be described later). A frusto-conical surface 2011 extends radially inwardly from and rearwardly from the annular planar thrust face 2009 to the cylindrical collar section 2008 of the bearing washer. Ten sunken keying features 2010 span the frusto-conical surface 2011 and the cylindrical collar section 2008, these allow material from the shaft 2000 to flow into them during shoulder rolling to create a key so that the rotation and torque can be resisted.

The moulded gear 2003 is secured between the bearing washer 2006 and a fine blank mild steel washer 2012 seen in FIG. 17, sandwiched between rolled shoulders 2013 and 2014, seen in FIGS. 18 and 19, which provide axial strength and torque resistance. The plane fine blank washer 2012 is located on the opposite side of the moulded gear 2003 to the bearing washer 2006 and butts up against the end 2007 of the bearing washer.

The keying features 2010 are depicted in FIG. 15 as having a half-moon shape. However, these features may take any suitable shape. Preferably, as depicted in FIGS. 31 to 33, the keying features 2010 will be v-shaped notches. Advantageously, such shapes provide excellent torsion resistance, whilst allowing material to flow therein during the shoulder rolling process. FIGS. 32 and 33 show the washers 2006, 2012 assembled in the opposite orientation to that shown in FIGS. 18 and 19 (that is, the opposite order in the axial direction), with the blank washer 2012 nearest the ball bearing 2400.

The plane shaft 2000 provides the basis for the shoulder rolling of the gear 2003 into position. The bearing washer 2006 is assembled to a first side of the moulded gear locating the mating key features 2002, 2005. The fine blank bearing washer 2012 is assembled to the gear 2003 on the other side. Next, the sub-assembly of moulded gear 2003 and bearing washers 2006 and 2012 is located onto the shaft 2000 mating the inner diameter of the bore in the bearing washer 2006 with the outer diameter of the plane shaft 2000. The shaft 2000 is then loaded into a shoulder roll machine. In FIG. 20 the shaft 2000 is schematically shown along with a shoulder roll tool 2020. The sub-assembly is fixed securely to the shaft 2000 by deforming the shaft using shoulder roll tools such as 2020 to form annular shoulders that apply a compressive force to and sandwich the gear 2003 between the two metal washers 2006, 2012. The shoulders resist movement of the gear 2003 both axially and radially. This method ensures that the two bearing washers 2006,2012 remain co-axial and minimises radial run out of the gear 2003 to the shaft 2000. The thrust face 2009 of the bearing washer 2006 is kept perpendicular to an axis of the shaft 2000 to a high level of accuracy using this method. The shoulder roll tools, such as 2020, have annular ring sections, such as 2021 which contact journal areas of the shaft 2000 to burnish them and improve their surface properties and surface finish. The journal areas are shown as 2022 and 2023 in FIGS. 18 and 19.

The load transmitted by the shoulder rolling process is resisted by the thrust face 2009 of the bearing washer 2006 and the blank washer 2012, thus preventing damage to the moulded gear 2003.

As a result of the loading from the shoulder rolling process, the gear washer assembly 2006, 2012 is compressed onto the shaft, thereby increasing the ability to transmit torque. Advantageously, shoulder rolling also increases the diameter of the shaft in the region where the inner diameter of the bore in the bearing washer 2006 mates with the outer diameter of the plane shaft 2000, thereby firmly fitting the shaft to the washer and preventing rocking of the gear on the shaft by achieving a very high order of concentricity of shaft to bore.

The high levels of concentricity and perpendicularity of the shoulder rolling dies are imparted to the sub-assembly of gear and shaft during the shoulder rolling process.

As mentioned above, the gearbox can be used in vehicle seat position adjustment mechanisms and thus be subject to high loading during a vehicle impact. Such high loading is transmitted from the shaft 2000 to the gearbox casing via the washer 2006 or washer 2012, bypassing the plastic gear 2003.

The casing consists of 2 casing halves provided by full zinc die cast bodies (2050 and 2051, shown in FIGS. 21,22) formed on one central mandrel assembly (a roller burnishing tool 2060 shown in FIGS. 23 and 24). The two die cast bodies 2050,2051 are designed with a number of unique features which, in combination with a specific process and with the use of a carefully designed roller burnishing tool, can ensure accurate gearbox alignment in several axes, improved surface finish and metallurgy of specific diameters, accurate diameters with very low total run out and accurate positioning.

There are two sets of four rollers, such as 2061 and 2062 of a first set and 2063 and 2064 of a second set seen in FIG. 24, provided in the roller burnishing tool 2060 which are used to ensure that when the two die cast halves are brought together over the shaft 2000, then the two diameters align themselves accurately. Axial v-grooves in the main diameters of both casings halves 2050, 2051, two sets of parallel v-grooves in each casing half (e.g. the v-grooves 2080-2083 of casing half 2051 and the v-grooves 2084-2087 of casing half 2050), allow excess material from roller burnishing the inner bore to flow into them and reduce the overall pressures and resistance during this process. The alignment of the four rollers of each set on the burnishing tool with the grooves in the casing halves aligns the casing halves with each other. Also, an independent force is applied to both casing halves 2050,2051 to ensure that they are held against a roller burnishing tool thrust face 2162.

Four spigots 2052, 2053, 2054 and 2055 (also called pins) are formed on one casing half 2050 and four corresponding sockets 2056, 2057, 2058 and 2059 (also called buckets) on the opposite casing half 2051. The casting halves 2050 and 2051 are aligned and the pins 2052, 2053, 2054 and 2055 are deformed by forcing them into the buckets 2056, 2057, 2058 and 2059, in order to provide an accurate positioning of the two casting halves relative to each other when they are subsequently dis-assembled and re-assembled and also to ensure that there is no movement in the casting during operation.

Rear end stop features 2070, 2071, 2072, 2073 are provided on the castings and are deformed to a known distance so that accurate axial location of the shaft can be achieved once castings are assembled around it.

The casing halves 2050,2051 are assembled over the precision roller burnishing tool 2060 with the rollers (e.g. 2061, 2062, 2063, 2064) on the tool located in the v-grooves (2080-2083 and 2084-2087) in the casing halves 2050 and 2051. This creates a v-block effect to centre the casings both over the tool and accurately aligns the two casing halves 2050,2051. When the clamping force is applied to the two casing halves then the rollers (e.g. 2061, 2062, 2063, 2064) indent into the grooves and this aligns the casing halves in two directions and fixes them from rotational motion about the mandrel axis. The tooling must be lubricated on the mandrel to ensure that the frictional force is minimised during roller burnishing. A clamping force is applied to the casing halves 2050,2051 to ensure that there is no axial movement of the halves relative to each other during the deformation process, plus a force must be applied independently to the each casting pushing them both against the front thrust face 2162 on the roller burnishing tool 2060. The rear end stop features 2070-2073 are then deformed by a central pin 2069 of the roller burnishing tool 2060 and this ensures that the datum bearing faces of both casing halves 2050,2051 and the end stop features are positioned accurately relative to each other. A closed loop controlled hydraulic actuator 4000 is incorporated in the roller burnishing tool to facilitate this, as can be seen in FIG. 24, and the abutment of the end surface 2069 with the end stop features is indicated in FIG. 25, which shows the roller burnishing tool in place in the casing half 2051. The axial motion is indicated by the arrows 4001 in FIG. 26.

While maintaining the axial force, leaving the two casing halves in tension between the end stop feature and the thrust face, the four spigots 2052-2055 are then deformed simultaneously by forcing them into the buckets 2056-2059 in the opposite casing half and to provide accurate casing location on subsequent disassembly and reassembly. This is achieved by clamping together the two casing halves 2050 and 2051 around the burnishing tool 2060 with the rollers, e.g. 2061-2064, of the burnishing tool 2060 indenting the abutting journal surfaces of the casing by up to 0.1 mm. The pins/spigots 2052-2055 are deformed through the elastic region of their material properties and into the plastic region, thus they maintain a constant deformed state even when force is withdrawn. Doing so with four pins/spigots eliminates any freeplay between the two halves and ensures they are both aligned about the front thrust face 2162. Preferably, the pins/spigots are designed to be “long and slender”, i.e. with an axial length exceeding diameter, the length being preferably at least a 1.1 multiple of diameter, or a 1.25 multiple or a 1.5 multiple or higher. This permits a significant degree of deformation to ensure good alignment of the finally assembled casing halves.

Once deformation is complete, then the pins/spigots 2052-2055 are removed partially from the buckets 2056-2059 and the axial force on the end stop is relaxed to allow the rotation of the roller burnishing tool. This is rotated 90° to provide an accurate bore diameter and improved surface finish. The final operation before dis-assembly is to ball burnish worm journal holes, e.g. 2100, for a worm gear. Whilst the gearbox is still aligned a carbide ball is pushed through the worm holes improving surface finish and improving the accuracy relative to each other. This process is indicated by the arrows 4002 in FIG. 26.

The worm gear sub-assembly of the gearbox will now be described with reference to FIGS. 27 to 30. It consists of 3 components; a mild steel worm gear 2200 shown in FIG. 27 and two journals 2201, 2202. The manufacturing process of the present invention creates an accurate thrust face for the worm gear with an improved surface finish.

The worm gear 2200 has a gear roll-formed on it to ensure accurate tooth profile and finish. The worm has turned journal diameters 2201 and 2202 provided at both ends, with a circumferentially extending groove 2203, 2204. Mild steel worm thrust washers such as washer 2205 of FIG. 28 are used in the sub-assembly, these being plane washers each with a thrust face, e.g. 2206, a small shoulder, e.g. 2207, protruding from the thrust face 2206 and a central through bore 2208. The thrust washers provide thrust faces for the worm gear sub-assembly along which the worm gear sub-assembly abuts the gearbox casing.

The thrust washers, e.g. 2205, are assembled onto the worm gear 2200 with their shoulders, e.g. 2207, facing away from the gear form. The assembly of worm gear 2200 and washers, e.g. 2205, is then loaded into a shoulder roll machine. FIG. 30 shows schematically how profiled shoulder roll ring tools, e.g. 2300, depress the shoulder 2207 of the thrust washer 2205 into the groove 2203 of the worm gear 2200 whilst engaging a thrust washer face 2206 to ensure that the face remains perpendicular to an axis of rotation of the worm gear 2200. The profiled roll tools, e.g. 2300, also have cylindrical surfaces, e.g. 2301, which contact the journal surfaces of the worm and burnish them to ensure that the journal surfaces are co-axial and to provide an improved surface finish for each. The profiled roll tools, e.g. 2300, also serve to lock the thrust washers on the worm gear to prevent relative rotation therebetween. The washer 2205 is shown mounted on the worm gear 2200 in FIG. 29.

The high levels of concentricity and perpendicularity of the shoulder rolling dies tools are imparted to the sub-assembly of worm gear 2200 and thrust washers (e.g. 2205) by the shoulder rolling process. Also the spacing between the thrust faces of the thrust washers is set to a high degree of accuracy.

Once all sub-assemblies have been assembled and the forming processes described above have been completed then components can be assembled together to form a completed gearbox. The spindle and gear sub-assembly, shown in FIGS. 8 and 19, is placed into the lower casing half 2050 of FIG. 21. A ball bearing 2400 (shown in FIG. 18) is inserted in a socket 2401 in an end of the shaft 2000 (the socket 2401 is shown in FIG. 12) using a ball staking operation to secure the ball bearing accurately and securely in the bore in the end of the shaft. Then an appropriate disc is placed between the ball bearing 2400 and the end stop provided by features 2070-2073 of the casing halves 2050, 2051 to ensure minimal axial movement. The worm gear sub-assembly, illustrated in part in FIG. 29, can then be placed into the casing half 2050 and located into the worm journal hole 2100 therein. The second casing half 2051 is then brought into abutment with the first casing half 2050 and the two casing halves 2050, 2051 are secured together using thread forming screws.

As depicted in FIGS. 34 to 36, in preferred embodiments, a jig is employed to accurately align the two casing halves 2050 and 2051 relative to the roller burnishing tool 2060. The jig comprises four support pins 5002, depicted in FIG. 34, onto which the first of the die casing halves 2050, 2051 is placed to be supported thereby. The four support pins 5002 are located so as to apply a force at the location of and in the direction of the axes of the spigots and sockets 2052-2059. These pins can be independently adjusted to ensure accurate alignment of the first cast body (i.e. to ensure that the upper face of the first cast body is flat).

Then the roller burnishing tool 2060 is placed again the first casing half, and the second casing half is placed upon both the roller burnishing tool 2060 and the first casing half, in a jig as seen in FIG. 35.

Advantageously, the rollers 2061-2064 engage the parallel grooves 2080-2087 to align and centre the cast bodies 2050, 2051 along the roller burnishing tool 2060 axis.

The jig further comprises adjustable sprung grub screws 5008, depicted in FIG. 36 which apply a force to the two casing halves 2050, 2051 to force them against the thrust face 2162 against which they are to be aligned in the direction of the axis of the roller burnishing tool 2060.

Then, four plungers 5006, seen in FIG. 35, are used to apply a force opposing that of the other support pins 5002. These opposing forces clamp the two casing halves 2050, 2051 together around the roller burnishing tool 2060.

The casing halves 2050, 2051 are thereby accurately constrained in all directions by the eight support pins 5002, 5006, the grub screws 5008 and thrust face 2162 of the roller burnishing tool 2060.

Next, accurate alignment of the axial position of the end stop features 2070-2073 is precisely defined by applying a force with the hydraulic actuator 4000 between thrust face 2162 and the end surface 2069 of the roller burnishing tool 2060. Since the hydraulic actuator can be accurately controlled, it is possible to precisely determine the movement of the end face 2069 relative to the thrust face 2162, and therefore determine the precise deformation of the end stop features 2070-2073.

Once the end stop has been deformed, and while the mandrel is kept in place by the hydraulic actuator to keep the casing halves in tension between the end stop and the opposed thrust face of the casing, the plungers 5006 are advanced to force the pins/spigots into the sockets/brackets (as previously described).

The plungers 5006 are next removed and, whilst the mandrel is still held in its position against the end stop, the rollers, which are located in a roller burnishing tool rotationally mounted as an inner mandrel element, are rotated to roller burnish or swage the bearing sections of the casing, as described above. The carbide ball bearing will then be pushed through the worm bores to provide a good surface finish.

1. A method of manufacture of a gearbox comprising:
forming a plurality of gearbox casing components each with an end stop feature;
in a pre-assembly stage, bringing the formed gearbox casing components together prior to final assembly with the end stop features of the casing components together defining an end stop internal to the casing;
applying pressure on the end stop to deform the end stop;
disassembling the gearbox casing components;
assembling the gearbox components around an end of a shaft, the shaft having a gear mounted thereon for rotation therewith and the assembled gearbox casing components encasing the gear; and
bringing the end of the shaft into abutment with the end stop either directly or via one or more spacer element(s) wherein:
deformation of the end stop in the pre-assembly stage sets a distance between the end stop and a surface of the gearbox casing which in the assembled gearbox faces a side surface of the gear, the said gear side surface facing away from the end stop.

2. A method as claimed in claim 1 wherein the end stop has a frusto-conical shape with a greatest diameter closest to the shaft end.

3. A method as claimed in claim 1 wherein the end stop is formed by aligned ridges of the gearbox casing components.

4. A method as claimed in claim 1 wherein the end of the shaft is provided with a closed bore in which a ball bearing is located and on assembly of the gearbox the ball bearing engages a spacer plate interposed between the shaft end and the end stop.

5. A method as claimed in claim 1 wherein pressure is applied to the end stop by using a rod advanced by an actuator; and
the rod is arranged relative to the casing parts to extend along an axis coincident with an axis of rotation of the shaft when the shaft is encased in the gearbox casing.

6. A method as claimed in claim 1 in which:
the assembled gearbox casing has a cylindrical bearing surface which encircles a portion of the shaft;
when the gearbox casing components are brought together in the pre-assembly stage they are forced together around a former which has rollers mounted therein which engage the cylindrical bearing surface of the gearbox casing and indent the bearing surface as the casing components are forced together; and
the former is rotated to roll the rollers around the bearing surface to deform the bearing surface.

7. A method as claimed in claim 1 wherein:
a first of the gearbox casing components is formed with spigots and a second of the gearbox casing components is formed with matching sockets;
when the gearbox casing arrangements are brought together in the pre-assembly stage the spigots of the first component are forced into the sockets of the second component and the spigots are deformed to fit into and match in shape with the sockets into which they are inserted.

8. A method as claimed in claim 7 wherein each spigot is hollow and is formed with a frusto-conical exterior surface and each socket has a frusto-conical surface engaged by the frusto-conical surface of a spigot.

9. A method as claimed in claim 8 wherein the frusto-conical surfaces of the spigots and sockets have a taper angle in the range of 4° to 8°.

10. A method as claimed in claim 9 wherein the frusto-conical surfaces of the spigots and sockets have a taper angle in the range 5° to 7°.

11. A method as claimed in claim 8 wherein in final assembly of the gearbox the gearbox casing components are secured together by fasteners passing through the spigots.

12. A method as claimed in claim 1 wherein the shaft is metal and the gear mounted on the shaft comprises an injection moulded toothed plastic gear wheel sandwiched between a pair of metal components and the gear is secured on the shaft by deforming metal of the shaft to form a pair of annular shoulders on the shaft securing the gear between them.

13. A method as claimed in claim 12 wherein the metal components have indented faces and during formation of the shoulders metal of the shaft flows into the indents in the faces to key the gear to rotate with the shaft.

14. A method as claimed in claim 1 wherein a worm gear is assembled in the gearbox casing in mesh with the gear mounted on the shaft and with an axis of rotation which extends transversely across the axis of the shaft.

15. A method as claimed in claim 14 wherein the worm gear is provided with bearing caps at both ends, interposed between the worm gear and the gearbox casing.

16. A method as claimed in claim 14 wherein: the worm gear is provided with a central gear form section sandwiched between a pair of end journal sections with a circumferential groove separating the central gear form section from each journal section; a pair of washers is provided for the worm gear, each washer having a planar section and a cylindrical shoulder section extending therefrom; and each washer is mounted on the worm gear by deforming the shoulder section thereof into one of the annular grooves with the planar section of the washer extending over an end face of the central gear form section.

17. A method of manufacture of a gearbox comprising:
forming a plurality of gearbox casing components which when assembled together provide a cylindrical bearing surface for a shaft;
in a pre-assembly stage forcing the gearbox casing components together around a former which has rollers mounted therein which engage the bearing surface of the gearbox casing and which indent the bearing surface as the casing components are forced together;
rotating the former to roll the rollers around the bearing surface to deform the bearing surface;
disassembling the gearbox casing components from around the former; and
assembling the gearbox components around an end of a shaft, the shaft having a gear mounted thereon for rotation therewith and the assembled gearbox casing components encasing the gear.

18. A method as claimed in claim 17 wherein:
a first of the gearbox casing components is formed with spigots and a second of the gearbox casing components is formed with matching sockets; and
when the gearbox casing components are brought together in the pre-assembly stage the spigots of the first casing component are forced into the sockets of the second casing component and the spigots are deformed to fit into and match in shape with the sockets into which they are inserted.

19. A method as claimed in claim 18 wherein each spigot is hollow and is formed with a frusto-conical exterior surface and each socket has a frusto-conical surface engaged by the frusto-conical surface of a spigot.

20. A method as claimed in claim 19 wherein the frusto-conical surfaces of the spigots and sockets have a taper angle in the range 4° to 8°.

21. A method as claimed in claim 20 wherein the frusto-conical surfaces of the spigots and sockets have a taper angle in the range 5° to 7°.

22. A method as claimed in claim 18 wherein in final assembly of the gearbox the gearbox casing components are secured together by fasteners passing through the spigots.

23. A method as claimed in claim 17 wherein the shaft is metal and the gear mounted on the shaft comprises an injection-moulded toothed plastic gear wheel sandwiched between a pair of metal components and the gear is secured on the shaft by deforming metal of the shaft to form a pair of annular shoulders on the shaft securing the gear between them.

24. A method as claimed in claim 23 wherein the metal components have indented faces and during formation of the shoulders metal of the shaft flows into the indents to key the gear to rotate with the shaft.

25. A method as claimed in claim 17 wherein a worm gear is assembled in the gearbox casing in mesh with the gear mounted on the shaft and with an axis of rotation which extends transversely across the axis of the shaft.

26. A method as claimed in claim 25 wherein the worm gear is provided with bearing caps at both ends, interposed between the worm gear and the gearbox casing.

27. A method as claimed in claim 25 wherein: the worm gear is provided with a central gear form section sandwiched between a pair of end journal sections with a circumferential groove separating the central gear form section from each journal section; a pair of washers is provided for the worm gear, each washer having a planar section and a cylindrical shoulder section extending therefrom; and each washer is mounted on the worm gear by deforming the shoulder section thereof into one of the annular grooves with the planar section of the washer extending over an end face of the central gear form section.

28. A method of manufacture of a gearbox comprising:
forming a plurality of gearbox casing components, a first of the gearbox casing components having spigots and a second of the gearbox components having matching sockets;
in a pre-assembly stage forcing the spigots of the first gearbox components into the sockets of the second gearbox component and in doing so deforming the spigots to fit into and match in shape with the sockets;
disassembling the gearbox casing components; and
assembling the gearbox components around an end of a shaft, the shaft having a gear mounted thereon for rotation therewith and the assembled gearbox casing components encasing the gear.

29. A method as claimed in claim 28 wherein each spigot is hollow and is formed with a frusto-conical exterior surface and each socket has a frusto-conical surface engaged by the frusto-conical surface of a spigot.

30. A method as claimed in claim 29 wherein the frusto-conical surfaces of the spigots and sockets have a taper angle in the range 4° to 8°.

31. A method as claimed in claim 30 wherein the frusto-conical surfaces of the spigots and sockets have a taper angle in the range 5° to 7°.

32. A method as claimed in claim 28 wherein in final assembly of the gearbox the gearbox casing components are secured together by fasteners passing through the spigots.

33. A method as claimed in claim 28 wherein the first and second casing components are metal and the metal of the spigots is plastically deformed during insertion of the spigots into the sockets, whilst the metal of the sockets remains elastic during said insertion and wherein the method comprises the step of keeping the spigots inserted in the sockets while the metal of the sockets relaxes to allow for further deformation of the spigots.

34. A method as claimed in claim 28 wherein the shaft is metal and the gear mounted on the shaft comprises an injection moulded toothed plastic gear wheel sandwiched between a pair of metal components and the gear wheel is secured on the shaft by deforming metal of the shaft to form a pair of annular shoulders on the shaft securing the gear wheel between them.

35. A method as claimed in claim 34 wherein the metal components have indented faces and during formation of the shoulders metal of the shaft flows into the indents in the faces to key the gear to rotate with the shaft.

36. A method as claimed in claim 28 wherein a worm gear is assembled in the gearbox casing in mesh with the gear mounted on the shaft and with an axis of rotation which extends transversely across the axis of the shaft.

37. A method as claimed in claim 36 wherein the worm gear is provided with bearing caps both ends interposed between the worm gear and the gearbox casing.

38. A method as claimed in claim 36 wherein: the worm gear is provided with a central gear form section sandwiched between a pair of end journal sections with a circumferential groove separating the central gear form section from each journal section; a pair of washers is provided for the worm gear, each washer having a planar section and a cylindrical shoulder section extending therefrom; and each washer is mounted on the worm gear by deforming the shoulder section thereof into one of the annular grooves with the planar section of the washer extending over an end face of the central gear form section.

39. A method of manufacture comprising:
moulding a toothed gear wheel from plastic having a central aperture and slots in an annular surface defining the central aperture;
fashioning a pair of metal load-bearing elements each having a central aperture therethrough and a load-bearing surface;
mounting the gear wheel and the bearing elements on a metal shaft, with the bearing elements sandwiching the plastic gear wheel and with a part of at least one of the load-bearing elements extending through the central aperture in the gear wheel to abut the other load-bearing element;
deforming the metal of the shaft to form a pair of annular shoulders on the shaft which engage the load-bearing surfaces of the load-bearing elements, with the forces applied to the load-bearing surfaces being transmitted through directly abutting faces of the load-bearing elements; and
allowing axial movement of the gear wheel and load-bearing elements as the shoulders are formed so that the shoulders fix the gear wheel in position axially on the shaft.

40. A method as claimed in claim 39 wherein the load-bearing surfaces have indents into which metal flows during formation of the shoulders and thereby the gear wheel is keyed to the shaft to rotate with the shaft.

41. A method as claimed in claim 39 wherein the toothed gear wheel is injection moulded.

42. A method as claimed in claim 40 wherein the load-bearing surfaces have radially outward portions that are not engaged by the shaft shoulders and which can function as bearing surfaces to react axial loading on the gear wheel when in use.

43. A gearbox comprising:
a plurality of metal casing components which together define both an internal end stop and a cylindrical burnished bearing surface for engaging a shaft, a first of the casing components having a plurality of spigots and a second of the casing components having a plurality of matching sockets;
a metal shaft having mounted thereon for rotation therewith a toothed gear, the toothed gear comprising a plastic toothed gear wheel sandwiched between a pair of metal load-bearing elements which are in turn engaged by a pair of shoulders formed integrally in the metal shaft; and
a worm gear; wherein:
the metal casing components encase and secure both the metal shaft with the toothed gear mounted thereon and also the worm gear, with the worm gear meshing with the toothed gear and with an axis of rotation of the worm gear being spaced apart from the shaft and perpendicular to a plane which includes rotation of the shaft;
the shaft is secured axially in the gearbox casing between the end stop, which faces an end of the shaft, and a gearbox casing surface which faces a bearing surface of one of the bearing elements, said bearing surface facing away from the end stop; and
a cylindrical portion of the shaft is surrounded by the cylindrical bearing surface formed by the assembled casing components.

44. A gearbox as claimed in claim 43 wherein:
a spacer element is interposed between the end of the shaft and the end stop; and
the ball bearing engages the spacer element.

45. A gearbox as claimed in claim 43 wherein a pair of bearing caps are provided for the worm gear and are interposed between the worm gear of the gearbox casing, one bearing cap being provided at each end of the worm gear.

46. A method as claimed in claim 43 wherein: the worm gear is provided with a central gear form section sandwiched between a pair of end journal sections with a circumferential groove separating the central gear form section from each journal section; a pair of washers is provided for the worm gear, each washer having a planar section and a cylindrical shoulder section extending therefrom; and each washer is mounted on the worm gear by deforming the shoulder section thereof into one of the annular grooves with the planar section of the washer extending over an end face of the central gear form section.
